(19) United States
(12) Patent Application Publication
(10) Pub. No.: US 2016/0271706 A1
(43) Pub. Date: Sep. 22, 2016

(54) ENDMILL WITH CONVEX RAMPING EDGE

(71) Applicant: Kennametal Inc., Latrobe, PA (US)

(72) Inventors: Frederick John Palmer, Warwickshire (GB); X. Daniel Fang, Brentwood, TN (US); Jean-Luc Dufour, Franklin, TN (US); David J. Wills, Greensburg, PA (US)

(21) Appl. No.: 14/660,977

(22) Filed: Mar. 18, 2015

(51) Int. Cl. B23C 5/10

(52) U.S. Cl. CPC B23C 5/10; B23C 2210/40; B23C 2210/126; B23C 2210/54

(57) ABSTRACT

An endmill having a longitudinal cutting axis includes a cutting edge portion having: a nose corner adjacent to a cutting periphery of the endmill; a convex cutting edge having an end adjacent to the nose corner and an opposing end closer to the longitudinal cutting axis; a straight cutting edge having a first end adjacent to the opposing end of the convex cutting edge and a second end closer to the longitudinal cutting axis; and a convex ramping edge adjacent to the second end of the straight cutting edge.

### BACKGROUND OF THE INVENTION

The present invention relates to an endmill and, more particularly, relates to an endmill with a convex ramping edge.

High feed machining can greatly increase machining productivity while maintaining a substantially improved surface quality on the machined workpiece surface. In addition, using a solid carbide high feed endmill can significantly increase tool life vs. the traditional high speed steel end mill. It is well known that high feed machining will result in smooth cut and evenly distributed stresses along the cutting edge under a rough machining condition, thus greatly increasing machining productivity while achieving an improved surface quality on the machined workpiece surface.

Recently, there have been increasing demands for reducing cost and increasing productivity in metal machining industries. As such, the innovative indexable carbide cutting inserts with high feed cutting edge geometry have been successfully developed and widely used in milling operations recently. There are typically two kinds of indexable carbide cutting inserts with high feed cutting edge geometry from a geometrical point of view. The first type is single-sided indexable carbide cutting inserts mounted on a steel tool holder, for example, those presented in U.S. Pat. No. 7,220,083 and U.S. Pat. No. 8,444,352. The second type is double-sided indexable carbide cutting inserts mounted on a steel tool holder, for example, those presented in U.S. Pat. No. 7,976,250 and U.S. Pat. No. 8,491,234. The single-sided indexable high feed cutting inserts provide positive cutting geometry thus having more machining functions such as ramping, plunging and helical hole making, while doubled sided indexable high feed cutting inserts provide more available cutting edges but in general are negative cutting geometry with limited functionality in, for example, ramping. In viewing indexable cutting inserts based high feed cutting tools like the two types as above described, the common drawback is the size limitation thus having difficulties to reach many areas, for example, pockets or grooves. The indexable range has a minimum size limitation due to the size of the inserts (currently 16 mm/⅝″).

Thus, there is a need to develop a cutting tool that overcomes disadvantages, limitations and shortcomings of known cutting tools. There is also a need to develop a high feed cutting tool that overcomes disadvantages, limitations and shortcomings of known high feed cutting tools.

### SUMMARY OF THE INVENTION

In accordance with an aspect of the invention, an endmill having a longitudinal cutting axis includes a cutting edge portion having: a nose corner adjacent to a cutting periphery of the endmill; a convex cutting edge having an end adjacent to the nose corner and an opposing end closer to the longitudinal cutting axis; a straight cutting edge having a first end adjacent to the opposing end of the convex cutting edge and a second end closer to the longitudinal cutting axis; and a convex ramping edge adjacent to the second end of the straight cutting edge.

In accordance with another aspect of the invention, an endmill having a longitudinal cutting axis includes at least one cutting edge portion having: a nose corner adjacent to a cutting periphery of the endmill; a convex cutting edge having an end adjacent to the nose corner and an opposing end, wherein a radius of the convex cutting edge is equal to or greater than half of a nominal diameter of the endmill; a straight cutting edge having a first end adjacent to the opposing end of the convex cutting edge and an opposing second end; and a convex ramping edge adjacent to the second end of the straight cutting edge, wherein the convex ramping edge is proximate to the longitudinal cutting axis.

In accordance with another aspect of the invention, an endmill having a longitudinal cutting axis includes a cutting edge portion having: a nose corner adjacent to a cutting periphery of the endmill; a first cutting edge having an end adjacent to the nose corner and an opposing end, wherein at least a portion of the first cutting edge is convex; a second cutting edge having a first end adjacent to the opposing end of the first cutting edge and a second end, wherein the second cutting edge is generally straight; and a ramping edge adjacent to the second end of the second cutting edge, wherein at least a portion of the ramping edge is convex and wherein the ramping edge is proximate to the longitudinal cutting axis.

In one aspect, there is a need to develop a high feed cutting tool in the form of solid carbide endmill, as presented herein, that provides a flexible cutting action to reach some areas like pockets and grooves in, for example, but not limited to, aerospace or die & mold operations that in an indexable cutting tool system is difficult to do. Such a solid carbide endmill with high feed capability will also have additional multiple milling functions including, but not limited to, ramping, plunging, profiling, curved slotting and helical hole making.

In another aspect, the solid carbide high feed endmill, as presented herein, has a convex cutting edge with large radius tangentially connected to a facet cutting edge perpendicular to the cutting axis, and then combined with an additional convex cutting edge or convex ramping edge at the other side of the facet cutting edge. Such a combined geometric feature built on a solid carbide endmill will provide a powerful and universal cutting tool for a wide range of machining applications in milling operations to achieve increased productivity and improved surface quality.

In yet another aspect, the solid carbide endmill with high feed capability of the present invention exhibits a combination of favorable cutting edge strength, and unique and specific cutting edge geometry, thus, allowing milling operations at relatively high feed rates and may be useful in face milling, slot milling, plunge milling, helical hole making and ramping operations.

In another aspect, the present invention sets forth aspects of a solid carbide high feed endmill having multiple flutes (or cutting edges/cutting teeth) for milling operations, such as, face milling, slot milling, plunge milling, helical hole making and ramping operations. The solid carbide high feed endmill exhibits a combination of favorable cutting edge strength and unique cutting edge geometry to facilitate all types of milling operations at relatively high feed rates.

In at least one aspect, each cutting edge of the solid carbide high feed endmill comprises a nose corner at the periphery of the endmill, at least one convex cutting edge adjacent to the said nose corner, a straight cutting edge (facet or wiper) adjacent to the said convex cutting edge, a convex ramping edge adjacent to the other end of the said straight cutting edge (facet), and wherein the convex cutting edge is equal or larger than the half of the nominal diameter of the endmill and wherein the straight cutting edge (facet) is perpendicular to the cutting axis of the endmill.

In another aspect, a solid carbide high feed endmill with multiple cutting teeth or flutes presented herein has a convex cutting edge with large radius tangentially connected to a facet cutting edge perpendicular to the cutting axis, and then combined with an additional convex cutting edge at the other end of the facet cutting edge. Such a combined geometric feature built on a solid carbide endmill will provide a powerful and universal cutting tool for a wide range of machining applications including high temperature alloys, titanium in milling operations to achieve increased productivity and improved surface quality. The solid carbide endmill with high feed capability exhibits a combination of favorable cutting edge strength, and unique cutting edge geometry, thus, allowing milling operations at relatively high feed rates and may be useful in face milling, slot milling, plunge milling, helical hole making and ramping operations.

In another aspect, the invention has two objectives: one to reduce the minimum diameter overlapping the current range, and two, to increase the flute count to improve productivity.

Accordingly, certain non-limiting embodiments of the solid carbide high feed endmill are described herein. The solid carbide high feed endmill may be of known sizes and shapes, and may be adapted for conventional use in a variety of milling applications. It will be understood that the present description may illustrate only those aspects of the invention relevant to providing a clear understanding thereof, and that certain aspects would be apparent to those of ordinary skill in the art. Therefore, such aspects as would not be necessary to facilitate a better understanding of the invention may not be present in order to simplify the description.

These and other aspects of the present invention will be more fully understood following a review of this specification and drawings.

### BRIEF DESCRIPTION OF THE DRAWINGS

FIG. 1 is a side elevation view of a solid carbide endmill, in accordance with an aspect of the invention.

FIG. 2 is an end view of the solid carbide endmill illustrated in FIG. 1, in accordance with an aspect of the invention.

FIG. 3 is an enlarged portion of the solid carbide endmill illustrated in FIG. 1, in accordance with an aspect of the invention.

FIG. 4 is an enlarged portion of the solid carbide endmill illustrated in FIG. 3, in accordance with an aspect of the invention.

FIG. 5 is an illustration of a cutting edge profile of a solid carbide endmill, in accordance with an aspect of the invention.

FIG. 6 is an enlarged portion of FIG. 5, in accordance with an aspect of the invention

### DETAILED DESCRIPTION

It is to be understood that certain descriptions of the present invention herein have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the present description of the invention, and are not necessary for a complete understanding of the present invention, a discussion of such elements and limitations is not provided herein. For example, as discussed herein, embodiments of the endmills of the present invention may be produced in the form of entire solid carbide or a solid carbide head comprising a cutting portion and attached to a steel bar by fusion or other manufacturing mechanical methods. The methods by which the high feed endmills are manufactured are generally understood by those of ordinary skill in the art and, accordingly, are not described in detail herein. In addition, all the geometric shapes should be considered to be modified by the term “substantially” wherein the term “substantially” means that the shape is formed within typical design and manufacturing tolerances for cutting inserts.

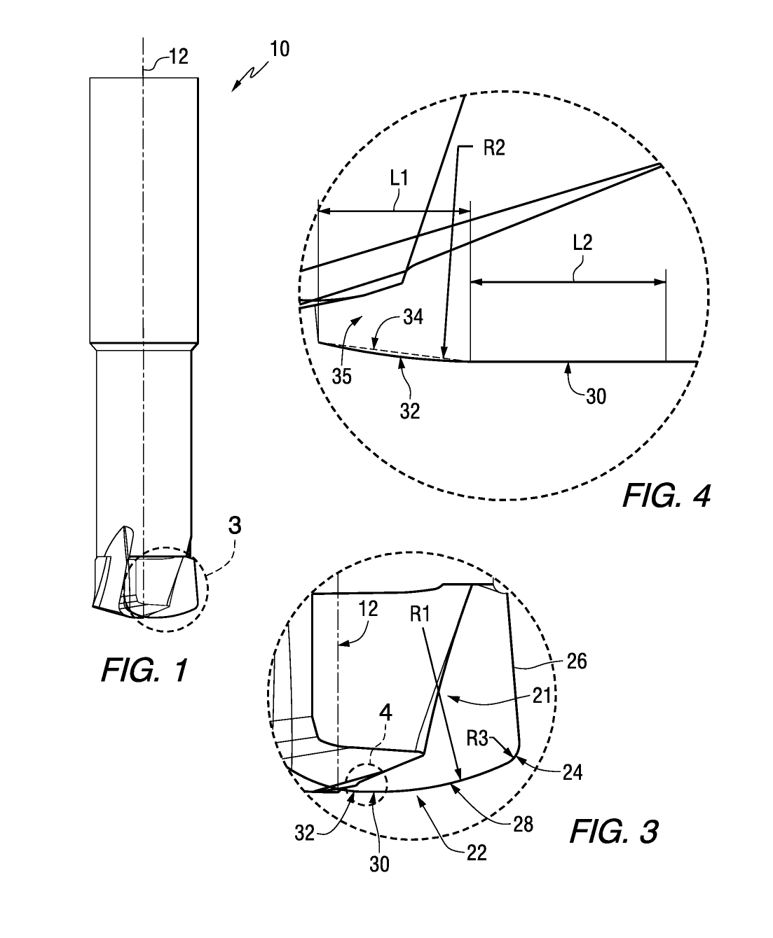

Referring to FIGS. 1-4, there is illustrated an endmill 10 having a longitudinal cutting axis 12, in accordance with an aspect of the invention. In one aspect, the endmill 10 is in the form of a solid carbide endmill. It will be appreciated that the endmill 10 may be in the form of various types of endmills and related cutting inserts as well.

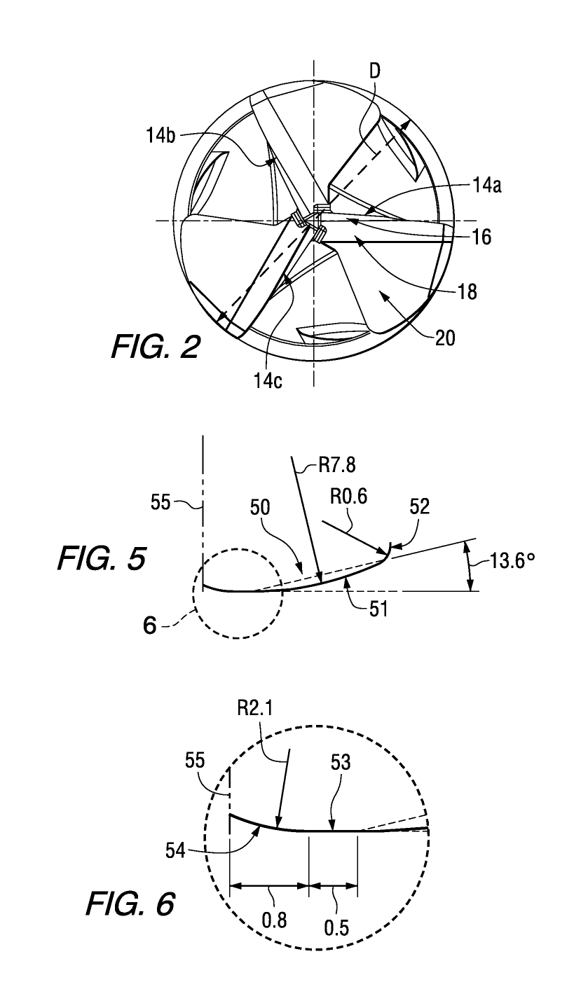

As shown in FIG. 2, the endmill 10 includes a nominal diameter D. The endmill 10 further includes multiple cutting flutes (or teeth) 14a, 14b and 14c. For each cutting tooth like, for example, 14a, there are multiple front end cutting clearance faces 16, 18 and 20 that provide positive cutting action. The endmill 10 also includes a rake cutting face 21 which may be configured in the form of, for example, a planar face, a curved face, a grooved face or a complex grooved face with multiple rake angles and edge preparations.

FIG. 3 is a scaled or enlarged view of area 3 of FIG. 1 and illustrates the details of a cutting edge portion 22 (e.g. which may be referred to as a high feed cutting edge) of the endmill 10. It will be appreciated that the endmill 10 may have additional or multiple cutting edge portions as well, in accordance with aspects of the invention.

Cutting edge portion 22 includes a nose corner 24 close to or adjacent to a cutting periphery 26 (i.e. close to the nominal diameter D). The cutting periphery 26 may have a cylindrical cutting area to produce a 90 degree wall or shoulder. The cutting edge portion 22 further includes a convex cutting edge 28 adjacent to the nose corner 24. In one aspect, the convex cutting edge 28 is configured having an end adjacent to the nose corner 24 and another or opposing end closer to the longitudinal cutting axis 12.

In accordance with an aspect of the invention, the cutting edge portion 22 also includes a straight cutting edge 30, which may also be referred to as a facet, adjacent to the convex cutting edge 28 (see, for example, FIGS. 3 and 4, wherein FIG. 4 is a scaled or enlarged view of area 4 of FIG. 3). In one aspect, the straight cutting edge 30 has a first end adjacent to the opposing end of the convex cutting edge 28 and a second end closer to the longitudinal cutting axis 12. In another aspect, the straight cutting edge 30 is configured to be perpendicular to the longitudinal cutting axis 12.

The cutting edge portion further includes a convex ramping edge 32 adjacent to the straight cutting edge 30. In one aspect, the convex ramping edge 32 includes an end adjacent to the second end of the straight cutting edge 30. In another aspect, the convex ramping edge 32 is configured proximate to the longitudinal cutting axis 12.

In another aspect of the invention, a radius R1 of the convex cutting edge 28 is equal to or greater than half of the nominal diameter D of the endmill 10. Such a geometry provides a combination of advantages exhibited by a round-shaped cutting insert with a much larger radius and a square-shaped cutting insert with a conventional size. In one aspect, the radius R1 of the convex cutting edge 28 is in the range of about 2.5 mm to about 35 mm.

In accordance with another aspect of the invention, a radius R2 of the convex ramping edge 32 is in the range of about 0.25 mm to about 15 mm. In addition, a length or horizontal dimension L1 of the convex ramping edge 32 is in the range of about 0.25 mm to about 25 mm.

In accordance with another aspect of the invention, a length L2 of the straight cutting edge 30 is in the range of about 0.2 mm to about 2 mm.

In accordance with another aspect of the invention, a radius R3 of the nose corner 24 is in the range of about 0.1 mm to about 4 mm.

Referring to FIG. 4, dotted line 34 is shown which may represent a corresponding straight ramping edge and is connected to the two ends of the convex ramping edge 32 of the present invention. In accordance with an important aspect of the present invention, the benefits of having a convex ramping edge 32 includes having a longer ramping edge for better edge stresses distribution, stronger ramping edge due to the round shape and smoother ramping action. In addition, the convex ramping edge 32 will benefit other milling operations like plunging, profiling, curved slotting, and helical hole making that need to use the ramping edge 32. As described herein, the radius of the convex ramping edge 32 ranges from a very small radius to a very large radius, depending, for example, on the value of its length or horizontal dimension L1. In one particular example, when the radius R2 is very large relative to its horizontal dimension L1, the convex ramping edge 32 will approach to a straight line (like the dotted line 34) or at least appear to be a straight line like the dotted line 34 but will remain convex. Further, there is a ramping cutting face 35, in a form of either a rake face with a rake angle or a grooved rake face, immediately behind the convex ramping edge 32 which in addition to ramping, also provides a cutting plane when the feed exceeds the facet width.

In another aspect of the invention, at least a portion of the convex cutting edge 28 is convex. In another aspect, other portions of the convex cutting edge 28 may be in a form of combined convex arcs and straight line, or in a form of spline curves.

In another aspect of the invention, at least a portion of the convex ramping edge 32 is convex. In another aspect, the convex ramping edge 32 may be in a form of combined straight edge and convex edge, or in a form of spline curves, or the combination of straight edge, convex edge and spline edge.

Referring to FIGS. 5 and 6, there is illustrated an example of the present invention in the form of a cutting edge profile 50 (wherein FIG. 6 is a scaled or enlarged view of area 6 of FIG. 5). Specifically, the cutting edge profile 50 of a high feed endmill, such as, for example endmill 10, includes a nose corner 52 with a radius of R0.6 mm, a convex cutting edge 51 having a radius of R7.8 mm which is larger than the half of the nominal diameter which is R5.0 mm (not labeled), a straight cutting edge (facet) 53 with a length of 0.5 mm, and a convex ramping edge 54 with a horizontal dimension of 0.8 mm and a radius of R2.1 mm. The angle 13.6° is the cutting approach angle of the convex cutting edge 51. As a feature of the invention, the straight cutting edge 53 is perpendicular to the longitudinal cutting axis 55. The convex ramping edge 54 has a curve radius of R2.1 mm for a horizontal dimension of 0.8 mm as an example but it may range from a very small radius to a very large radius, and in a particular case when the radius is very large relative to its horizontal dimension, the convex ramping edge appears to be a straight line but remains convex.

Whereas particular aspects of this invention have been described above for purposes of illustration, it will be evident to those skilled in the art that numerous variations of the details of the present invention may be made without departing from the invention.

1. An endmill having a longitudinal cutting axis, comprising:
a cutting edge portion including:
a nose corner adjacent to a cutting periphery of the endmill;
a convex cutting edge having an end adjacent to the nose corner and an opposing end closer to the longitudinal cutting axis;
a straight cutting edge having a first end adjacent to the opposing end of the convex cutting edge and a second end closer to the longitudinal cutting axis; and
a convex ramping edge adjacent to the second end of the straight cutting edge.

2. The endmill of claim 1, wherein a radius of the convex cutting edge is equal to or greater than half of a nominal diameter of the endmill.

3. The endmill of claim 2, wherein the radius of the convex cutting edge is in the range of about 2.5 mm to about 35 mm.

4. The endmill of claim 1, wherein the convex ramping edge is proximate to the longitudinal cutting axis.

5. The endmill of claim 1, wherein a radius of the convex ramping edge is in the range of about 0.25 mm to about 15 mm.

6. The endmill of claim 1, wherein a length of the convex ramping edge is in the range of about 0.25 mm to about 25 mm.

7. The endmill of claim 1, wherein a length of the straight cutting edge is in the range of about 0.2 mm to about 2 mm.

8. The endmill of claim 1, wherein a radius of the nose corner is in the range of about 0.1 mm to about 4 mm.

9. The endmill of claim 1, further including additional cutting edge portions.

10. The endmill of claim 9, further including a cutting flute and a rake cutting face corresponding to each cutting edge portion.

11. The endmill of claim 1, wherein the straight cutting edge is perpendicular to the longitudinal cutting axis.

12. An endmill having a longitudinal cutting axis, comprising:
at least one cutting edge portion including:
a nose corner adjacent to a cutting periphery of the endmill;
a convex cutting edge having an end adjacent to the nose corner and an opposing end, wherein a radius of the convex cutting edge is equal to or greater than half of a nominal diameter of the endmill;
a straight cutting edge having a first end adjacent to the opposing end of the convex cutting edge and an opposing second end; and
a convex ramping edge adjacent to the second end of the straight cutting edge, wherein the convex ramping edge is proximate to the longitudinal cutting axis.

13. The endmill of claim 12, wherein the radius of the convex cutting edge is in the range of about 2.5 mm to about 35 mm.

14. The endmill of claim 12, wherein a radius of the convex ramping edge is in the range of about 0.25 mm to about 15 mm.

15. The endmill of claim 12, wherein a length of the convex ramping edge is in the range of about 0.25 mm to about 25 mm.

16. The endmill of claim 12, wherein a length of the straight cutting edge is in the range of about 0.2 mm to about 2 mm.

17. The endmill of claim 12, wherein a radius of the nose corner is in the range of about 0.1 mm to about 4 mm.

18. The endmill of claim 12, wherein the endmill is in the form of a solid carbide endmill.

19. The endmill of claim 12, wherein the straight cutting edge is perpendicular to the longitudinal cutting axis.

20. An endmill having a longitudinal cutting axis, comprising:
a cutting edge portion including:
a nose corner adjacent to a cutting periphery of the endmill;
a first cutting edge having an end adjacent to the nose corner and an opposing end, wherein at least a portion of the first cutting edge is convex;
a second cutting edge having a first end adjacent to the opposing end of the first cutting edge and a second end, wherein the second cutting edge is generally straight; and
a ramping edge adjacent to the second end of the second cutting edge, wherein at least a portion of the ramping edge is convex and wherein the ramping edge is proximate to the longitudinal cutting axis.
